(19) United States
(12) Patent Application Publication
(10) Pub. No.: US 2003/0053817 A1
(43) Pub. Date: Mar. 20, 2003

(54) Image forming apparatus and printer driver program

(75) Inventor: Takashi Nagaya, Ibaraki (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/242,700

(22) Filed: Sep. 13, 2002

(30) Foreign Application Priority Data
Sep. 17, 2001 (JP) 281498/2001 (PAT.

(51) Int. Cl. G03G 15/00

(52) U.S. Cl. 399/82

(57) ABSTRACT

To prevent mixture of papers discharged by an image forming apparatus when sheet post-treatment equipment that executes post-treatment on papers discharged by the image forming apparatus post-treats papers supplied directly to the sheet post-treatment equipment by a user. When an off-line mode is selected via an operation panel of the sheet post-treatment equipment, a sheet post-treatment equipment controller notifies an engine controller of the image forming apparatus that this mode has been selected. The engine controller indicates on an operation panel that the off-line mode has been selected, and disables an image formation start instruction key.

### BACKGROUND OF THE INVENTION

1. Field of the Invention

The present invention relates to an image forming apparatus that executes a predetermined process on a sheet with an image formed thereon, and a printer driver program installed in and executed by a host computer in order to allow the image forming apparatus to form images.

2. Related Background Art

Sheet post-treatment equipment is connected to an image forming apparatus such as an electrophotographic copier or a laser beam printer to execute a binding process or the like on papers discharged by the image forming apparatus. The sheet post-treatment equipment shifts sheet guides of a post-treatment section to a position corresponding to the size of a group of papers to be discharged, and then executes the biding process or the like by causing the sheet guides to align sheets discharged by the image forming apparatus.

The sheet post-treatment equipment connected to the image forming apparatus automatically post-treats papers discharged by the image forming apparatus and then bind (or staple) them. However, for the convenience of a user and the effective use of the sheet post-treatment equipment, it is desirable to have a function of allowing the user to insert papers directly into the sheet post-treatment equipment and then manually start post-treatment.

However, after the user has inserted the papers into the sheet post-treatment equipment and before the user gives an instruction for post-treatment, in order to manually start the post-treatment, if another user starts an image forming operation in the image forming apparatus, the inserted papers are mixed with papers discharged by the image forming apparatus, inside the sheet post-treatment equipment. This raises such a problem that it is impossible to manually start the post-treatment. Further, these papers, lying in the sheet post-treatment equipment, must be removed. This is cumbersome.

### SUMMARY OF THE INVENTION

It is an object of the present invention to provide a sheet processing apparatus, an image forming apparatus, and a printer driver program, which serve to solve the above problems.

It is another object of the present invention to provide an image forming apparatus comprising image forming means for forming an image on a sheet, sheet processing means for executing a predetermined process on the sheet, selecting means for selecting either a first mode in which a predetermined process is executed on a sheet supplied by the image forming means or a second mode in which a predetermined process is executed on a sheet supplied to the sheet processing means by a user, and inhibiting means for inhibiting the image forming means from performing an image forming operation in response to selection of the second mode by the selection means.

It is still another object of the present invention to provide a printer driver program installed in and executed by a host computer in order to allow the image forming apparatus to form an image, the printer driver program being characterized by comprising a program for executing a determining step of determining whether or not the host computer is notified of the selection of the second mode in the sheet processing apparatus by notifying means, and an indicating step of indicating in a printer driver screen displayed on the display of the host computer that the image forming apparatus cannot execute the image forming operation, in response to determination that the selection of the second mode is notified, in the determining step.

The other objects and features of the present invention will be apparent from the following description and drawings.

### BRIEF DESCRIPTION OF THE DRAWINGS

FIG. 1 is a perspective view of an image forming apparatus 2 and sheet post-treatment equipment 1 according to an embodiment of the present invention;

FIG. 2 is a perspective view of the sheet post-treatment equipment as viewed at another angle;

FIG. 3 is a sectional view of the sheet post-treatment equipment 1 as viewed from the front;

FIG. 4 is a block diagram of the sheet post-treatment equipment 1 and the image forming apparatus 2;

FIG. 5 is a diagram showing an operation panel 8 provided on the sheet post-treatment equipment 1;

FIG. 6 is a diagram showing an operation panel 10 provided on the image forming apparatus 2;

FIG. 7 is a flow chart showing the case in which a user uses an on-line mode;

FIG. 8 is a flow chart showing the case in which the user uses an off-line mode;

FIG. 9 is a flow chart showing a process executed by the operation panel 10;

FIG. 10 is a control flow chart for the sheet post-treatment equipment 1;

FIG. 11 is a control flow chart for the image forming apparatus 2;

FIG. 12 is a control flow chart for a printer driver program executed by a host computer 50; and

FIG. 13 is a diagram showing a display screen of a printer driver of the host computer 50.

### DETAILED DESCRIPTION OF THE PREFERRED EMBODIMENTS

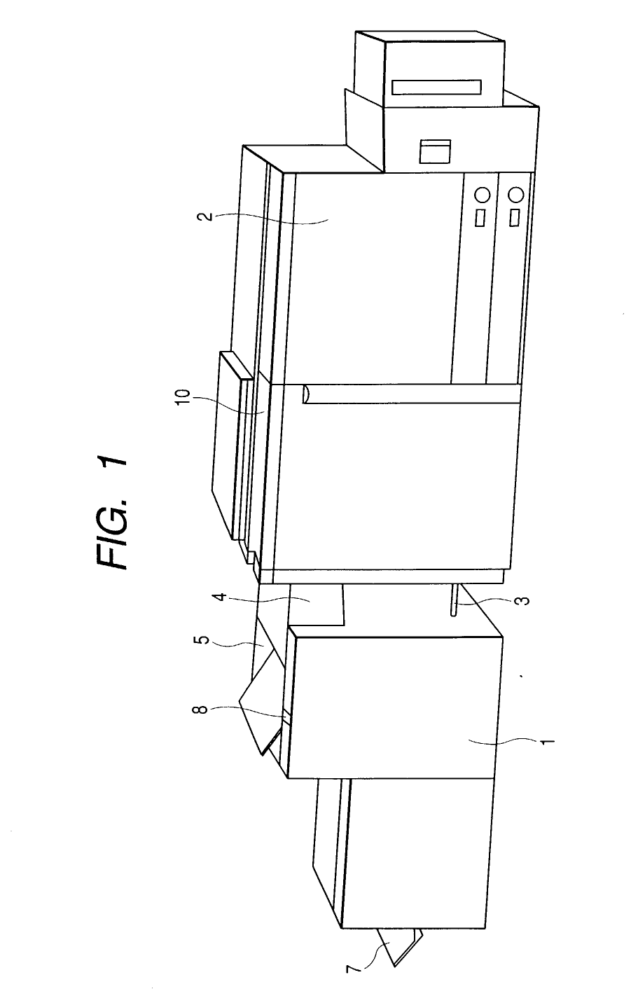

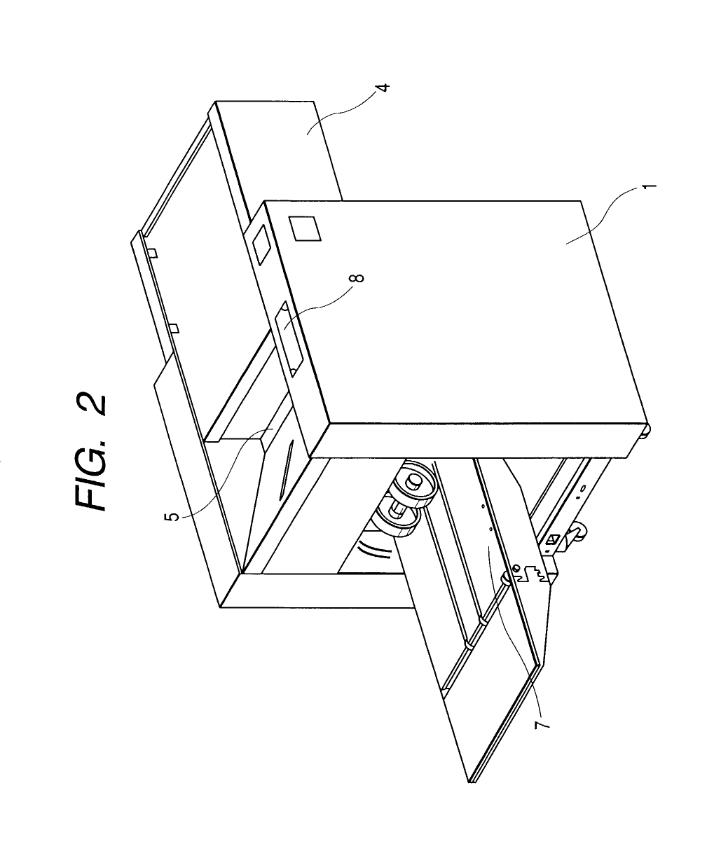

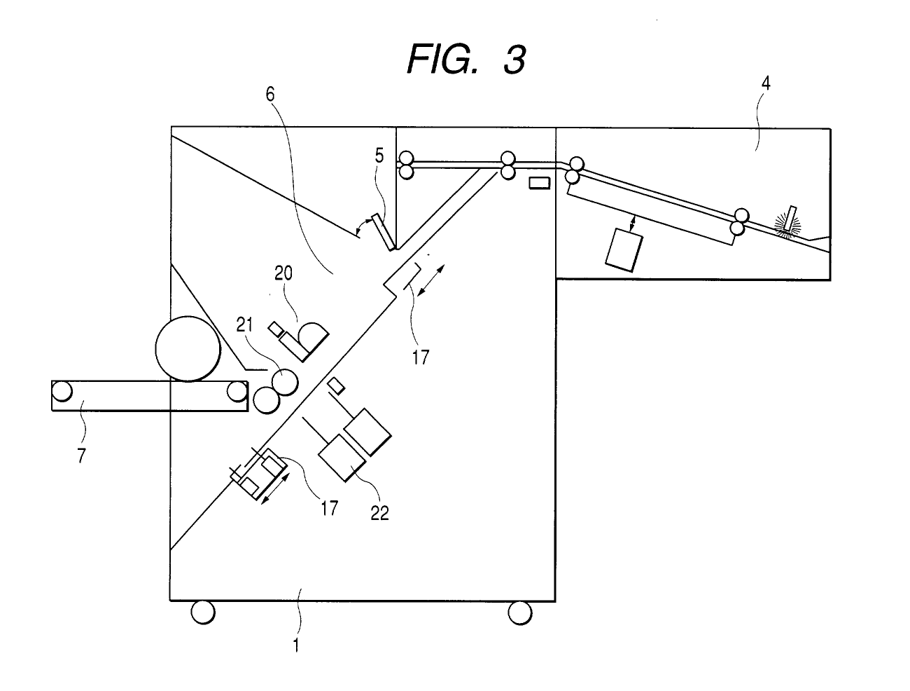

FIG. 1 is a perspective view of an image forming apparatus 2 and sheet post-treatment equipment 1 according to an embodiment of the present invention. FIG. 2 is a perspective view of the sheet post-treatment equipment as viewed at another angle. FIG. 3 is a sectional view of the sheet post-treatment equipment 1 as viewed from the front. The image forming apparatus 2 forms an image on paper and discharges the paper. The sheet post-treatment equipment 1 is connected to the image forming apparatus 2 to execute a binding operation papers discharged by the image forming apparatus, thereby producing bound papers. The image forming apparatus 2 and the sheet bound equipment 1 communicate information with each other via a communication line 3 as described later.

The sheet post-treatment equipment 1 selectively executes either an on-line or off-line mode. In the on-line mode, the sheet post-treatment equipment 1 operates synchronously on the basis of an instruction from the image forming apparatus 2. In the on-line mode, the image forming apparatus 2 transmits information on post-treatment to the sheet post-treatment equipment 1 via to signal line 3 on the basis of information input from an operation panel 10 of the image forming apparatus or information provided by external equipment such as a personal computer (not shown). The contents of the transmitted information include the size of papers, a post-treatment method, the number of papers contained in one copy (bundle or volume), and the number of copies (bundles or volumes). The sheet post-treatment equipment 1 executes a post-treatment operation on the basis of the information provided by the image forming apparatus 2. On the other hand, in the off-line mode, the sheet post-treatment equipment 1 operates asynchronously irrespective of instructions from the image forming apparatus 2. In the off-line mode, a user operates the operation panel 8 to specify a paper size, a post-treatment method, etc. to execute the post-treatment operation.

The sheet post-treatment equipment 1 comprises a post-treatment section 6 that staples papers, a conveying path 4 through which paper from the image forming apparatus 2 is introduced into the post-treatment section 6, a manual paper feeding slot 5 through which the user manually feeds the paper directly into the post-treatment section 6, a discharge section 7 that discharges post-treated (or bound) papers generated by the post-treatment section 6, and an operation panel 8. The post-treatment section 6 comprises movable sheet guides 17 that adjust alignment and folding positions of papers in a paper conveying direction (sub-scanning direction) and a corresponding cross direction (main scanning direction) depending on the size of papers to be treated. The post-treatment section 6 also comprises a stapler 20 that binds papers, a roller 21 that folds papers, and a movable plate 22 that pushes papers against the roller 21. These arrangements enable the post-treatment section 6 to produce post-treated papers such as a magazine or a pamphlet. Further, the image forming apparatus 2 comprises well-known means for forming images and the operation panel 10. The manual paper feeding slot 5 is constructed so as to be manually opened and closed.

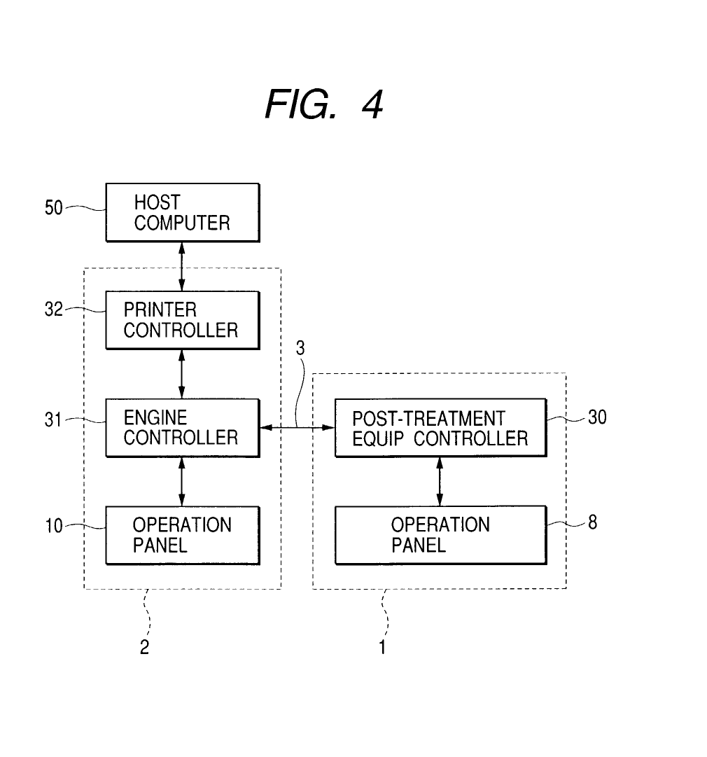

FIG. 4 is a block diagram of the sheet post-treatment equipment 1 and the image forming apparatus 2. A sheet post-treatment equipment controller 30 controls the sheet post-treatment equipment 1 on the basis of information received from the image forming apparatus 2 via the signal line 3 or information input from the operation panel 8. An engine controller 31 controls a copying operation (image forming operation) performed by the image forming apparatus 2 on the basis of the information input from the operation panel 10, and controls a printing operation (image forming operation) performed by the image forming apparatus 2 on the basis of image information and control information input by a printer controller 32. The printer controller 32 generates image information and control information for the engine controller 31 on the basis of a print job containing a page description language and a control command, received from a host computer 50 and output them to the engine controller 31.

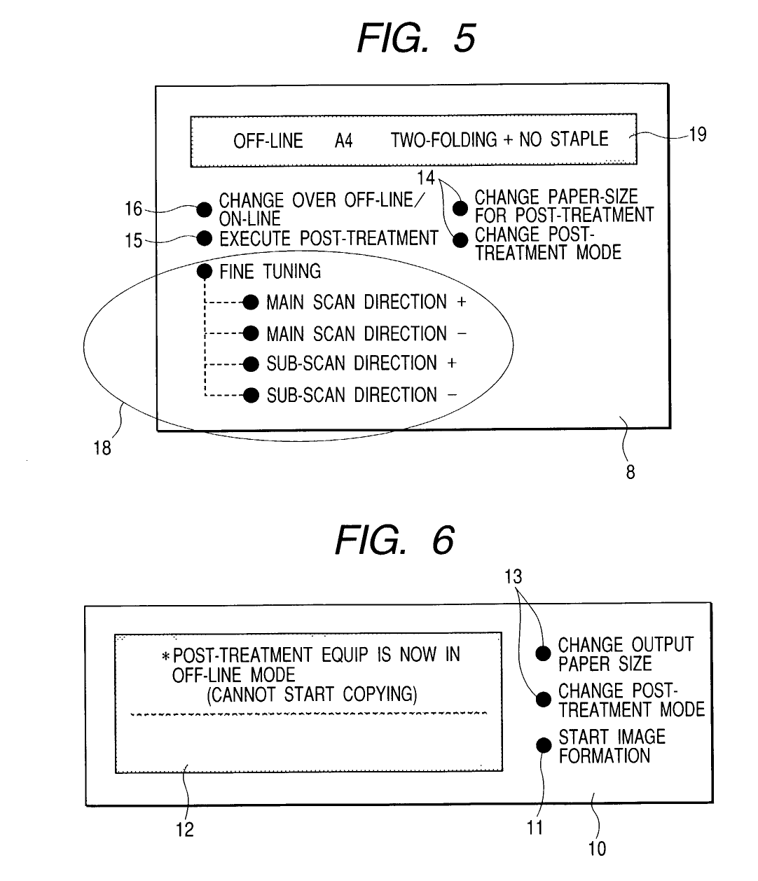

FIG. 5 is a diagram showing the operation panel 8 provided on the sheet post-treatment equipment 1. The operation panel 8 comprises an off-line post-treatment information input key 14 used to input information on post-treatment such as the size of papers to be post-treated and a post-treatment mode, a post-treatment execution key 15 used to start post-treatment in the off-line mode, a sheet post-treatment equipment mode change-over key 16 used to determine whether the sheet post-treatment equipment is operated in the off-line or on-line mode, a sheet guide position fine-tuning key 18 used to fine-tune the positions of the sheet guides 17 in the main scanning direction and sub-scanning direction, and a display 19 that displays the size of papers to be post-processed, the post-treatment mode, the on-line mode/off-line mode, or the like.

FIG. 6 is a diagram showing the operation panel 10 provided on the image forming apparatus 2. The operation panel 10 comprises an image formation start key 11, a display 12 that displays the contents of an image formation mode and the post-treatment mode, and an on-line post-treatment information input key 13 used to input information on post-treatment such as the size of papers and the post-treatment mode.

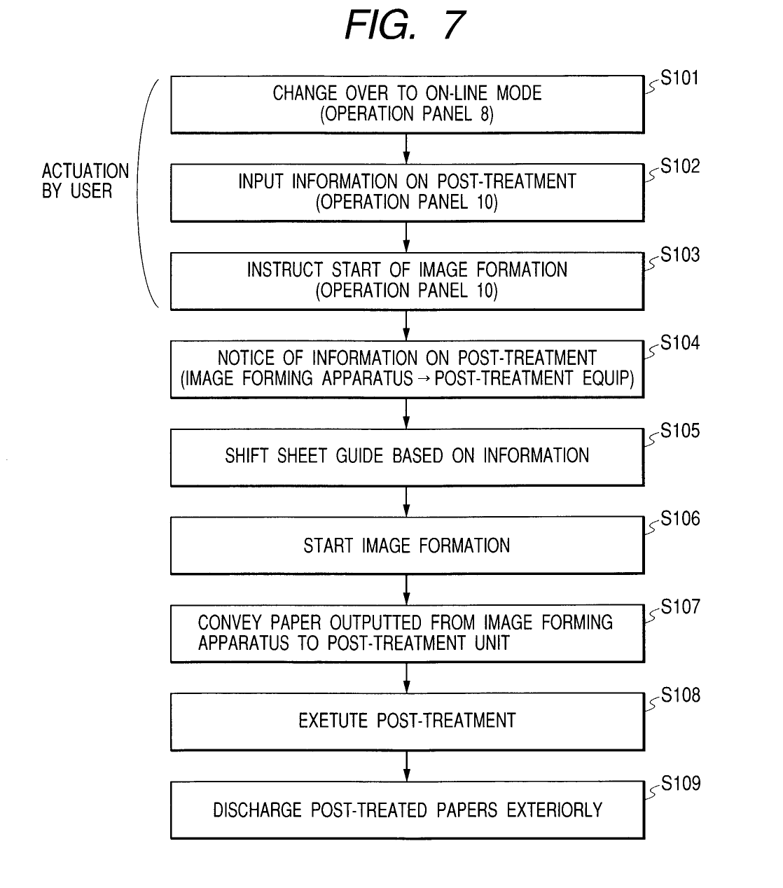

FIG. 7 is a flow chart showing the case in which a user uses an on-line mode. If the on-line mode is used, the user uses the sheet post-treatment equipment mode change-over key 16 on the operation panel 8 to specify the on-line mode (S101). Then, the user inputs information on post-treatment, i.e. the size of papers, the type of the papers, a post-treatment method (two-folding: yes/no, binding process: yes/no, trimming: yes/no), the number of papers contained in one copy (bundle or volume), and the number of copies (bundles or volumes), using the on-line post-treatment information input key 13 on the image forming apparatus operation panel 10 of the image forming apparatus or using external equipment (not shown) connected to the image forming apparatus 2 (S102). Then, the user gives an instruction to start an image output, using the image formation start key 11 of the operation panel 10 of the image forming apparatus 2 or using the external equipment (not shown) connected to the image forming apparatus 2 (S103), thus allowing the image forming apparatus 2 to automatically provide information on post-treatment to the sheet post-treatment equipment 1 via the signal line 3 (S104). On the basis of the provided information on the post-treatment, the post-treatment section 6 of the sheet post-treatment equipment 1, for example, shifts the sheet guides 17 in the main scanning direction and sub-scanning direction to positions corresponding to the size of papers (S105). Once the sheet guides 17 have been completely shifted, the image forming apparatus 2 starts outputting paper (S106). The outputted paper is conveyed through the conveying path 4 to the post-treatment section 6 (S107). A group of papers housed in the post-treatment section 6 are post-treated on the basis of the provided information on the post-treatment (S108) and then discharged out of the apparatus through the discharge section 7 (S109).

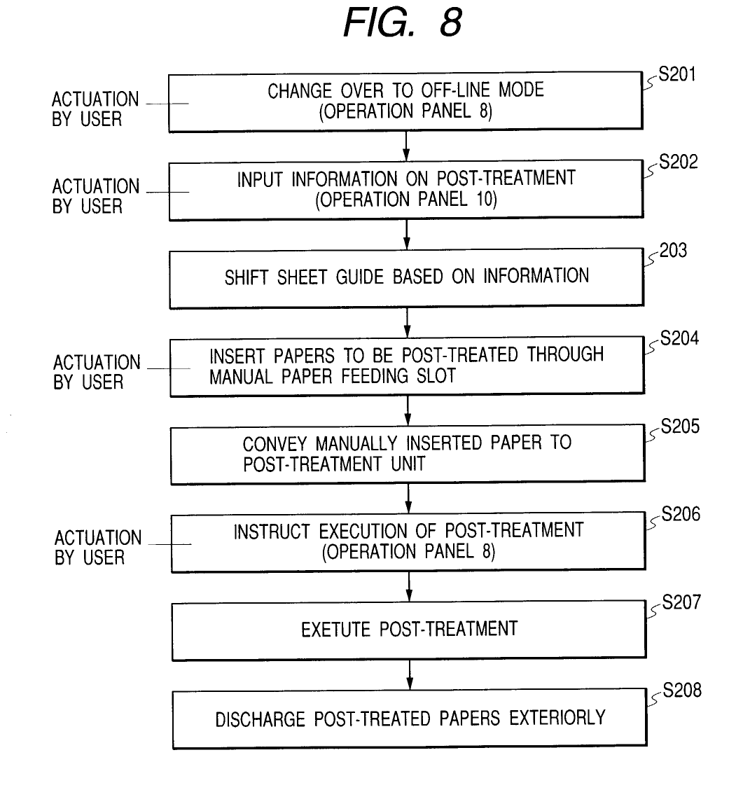

FIG. 8 is a flow chart showing the case in which the user uses an off-line mode. If the offline mode is used, the user uses the sheet post-treatment equipment mode change-over key 16 on the operation panel 8 to specify the off-line mode (S201). Then, the user inputs information on post-treatment, i.e. the size of papers, the type of the papers, a post-treatment method (two-folding: yes/no, binding process: yes/no, trimming (trimming an end of post-treated or bound papers): yes/no), the number of papers contained in one copy (bundle or volume), etc., using the off-line post-treatment information input key 14 on the operation panel 8 of the image forming apparatus (S202). On the basis of the provided information on the post-treatment, the post-treatment section 6 of the sheet post-treatment equipment 1, for example, shifts the sheet guides 17 in the main scanning direction and sub-scanning direction to positions corresponding to the size of papers (S203). Then, the user inserts a bundle of papers to be post-processed into the manual paper feeding slot 5 (S204). The bundle of papers inserted through the manual paper feeding slot 5 are conveyed to the post-treatment section 6 (S205). Then, the user gives an instruction to start the post-treatment, using the post-treatment execution key 15 on the operation panel 8 (S206). Thus, the group of papers housed in the post-treatment section 6 are post-treated on the basis of the provided information on the post-treatment (S207) and then discharged out of the apparatus through the discharge section 7 (S208).

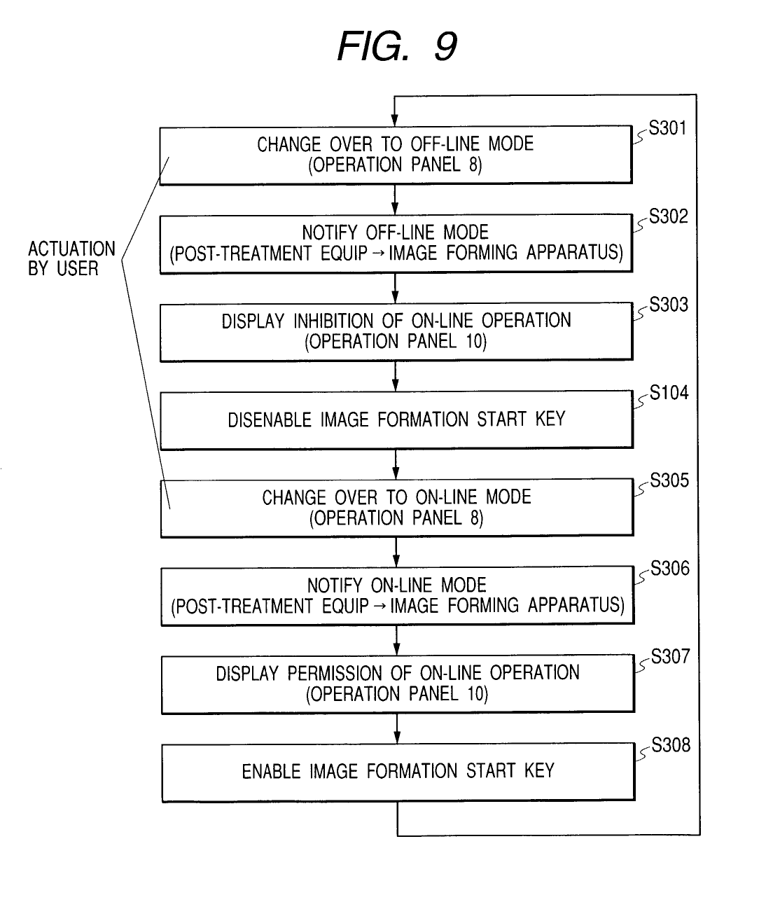

FIG. 9 is a flow chart showing a process executed by the operation panel 10 when the operation mode of the sheet post-treatment equipment 1 is alternately changed over to the on-line and off-line modes. When the user specifies the off-line mode using the sheet post-treatment equipment mode changeover key 16 on the operation panel 8 (S301), the sheet post-treatment equipment 1 notifies the image forming apparatus 2 of the off-line mode via the signal line 3 (S302). Notified of the off-line mode, the image forming apparatus 2 indicates on the display 12 of the operation panel 8 that the sheet post-treatment equipment 1 is in the off-line mode. It also indicates that an image formation start instruction, given using the image formation start key 11, is inhibited (S303), thereby disabling the image formation start key 11 (S304). At the same time, the externally connected equipment (not shown) displays similar information to disable the image formation start instruction. This information is continuously displayed with the image formation start instruction continuously disabled until the user specifies the on-line mode using the sheet post-treatment equipment mode change-ver key 16 on the operation panel 8.

When the user specifies the on-line mode using the sheet post-treatment equipment mode change-over key 16 on the operation panel 8 (S305), the sheet post-treatment equipment 1 notifies the image forming apparatus 2 of the on-line mode via the signal line 3 (S306). Notified of the on-line mode, the image forming apparatus 2 indicates on the display 12 of the operation panel 8 that the sheet post-treatment equipment 1 is in the on-line mode. It also indicates that the image formation start instruction, given using the image formation start key 11, is enabled (S307), thereby enabling the image formation start key 11 (S308). At the same time, the externally connected equipment (not shown) displays similar information to enable the image formation start instruction. This information is continuously enabled with the image formation start instruction continuously enabled until the user specifies the off-line mode using the sheet post-treatment equipment mode change-ver key 16 on the operation panel 8.

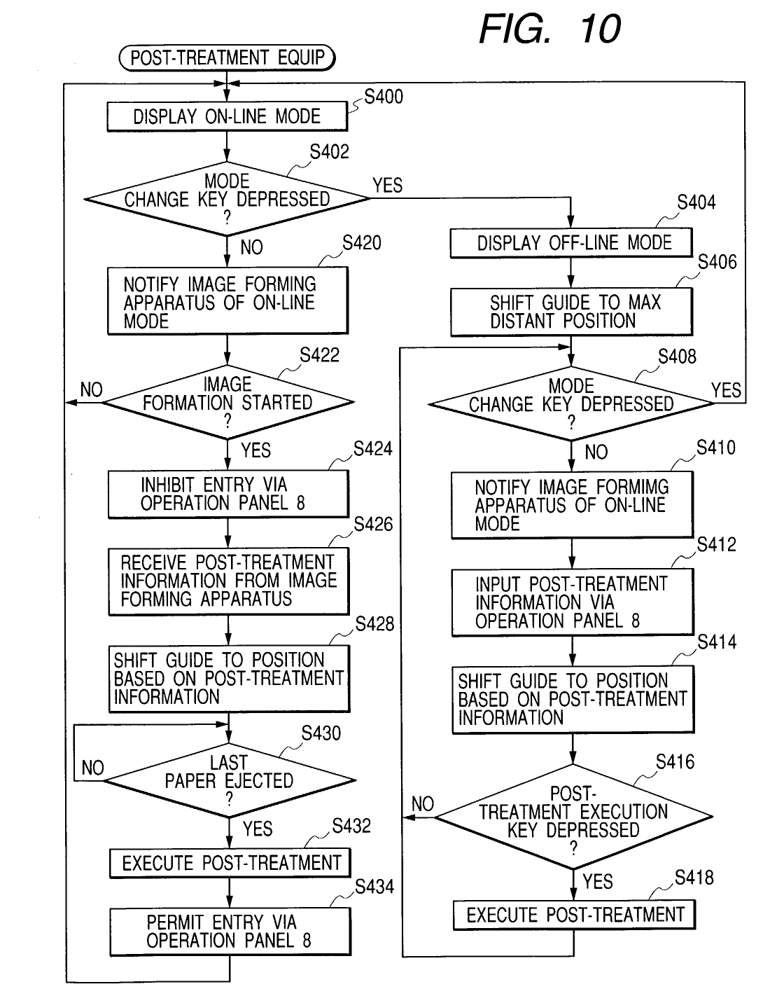

FIG. 10 is a flow chart showing how the sheet post-treatment equipment 1 is controlled by the sheet post-treatment equipment controller 30. When the sheet post-treatment equipment 1 is turned on, the display 12 on the operation panel 8 indicates the online mode (S400). Then, when the sheet post-treatment equipment mode change-over key 16 is depressed (S402), the display 12 indicates the offline mode as shown in FIG. 5 (S404). The sheet guides 17 are shifted to their max distant positions (S406). When the sheet post-treatment equipment mode change-over key 16 is depressed (S408), the process returns to step S400. If the sheet post-treatment equipment mode change-over key 16 is not depressed, the sheet post-treatment equipment controller 30 notifies the engine controller 31 of the image forming apparatus 2 that the sheet post-treatment equipment 1 is in the off-line mode (S410). The sheet post-treatment equipment controller 30 then inputs post-treatment information set by the user, via the operation panel 8 (S412). Then, the sheet post-treatment equipment controller shifts the sheet guides 17 to positions corresponding to the post-treatment information (post-treatment paper size information) (S414). Then, the sheet post-treatment equipment controller determines whether or not the post-treatment execution key 15 has been depressed (S416). If this key 15 has not been depressed, the process returns to step S408. If this key 15 has been depressed, the sheet post-treatment equipment controller causes the sheet post-treatment equipment 1 to execute the post-treatment corresponding to the post-treatment information (S418). The process then returns to step S408.

If it is determined at step S402 that the sheet post-treatment equipment mode change-over key 16 has not been depressed, the sheet post-treatment equipment controller notifies, via the signal line 3, the engine controller 31 of the image forming apparatus 2 that the sheet post-treatment equipment 1 is in the on-line mode (S420). The sheet post-treatment equipment controller then determines whether or nor the image forming apparatus 2 has started an image forming operation (S422). If the image forming apparatus 2 has not started an image forming operation, the process returns to step S400. If the image forming apparatus 2 has started an image forming operation, the sheet post-treatment equipment controller inhibits entries via the operation panel 8 (S424) and receives post-treatment information from the engine controller 31 (S426) via the signal line 3. Then, the sheet post-treatment equipment controller shifts the sheet guides 17 to positions corresponding to this post-treatment information (paper size information) (S428). Then, notified by the engine controller 31 that the last paper has been discharged (S430), the sheet post-treatment equipment controller causes the sheet post-treatment equipment 1 to execute the post-treatment corresponding to the post-treatment information (S432) and permits entries via the operation panel 8 (S434). The process then returns to step S400.

In view of such cases that the image forming apparatus 2 may be required to form a plurality of sets of images or an instruction to perform a different image forming operation may be given during an image forming operation, the process of the sheet port-treatment equipment controllers may be changed in the following manner. That is, the engine controller 31 provides the sheet post-treatment equipment controller 30 with information indicating that an image forming operation is being performed. Then, after the processing at step S432, the sheet post-treatment equipment controller determines whether or not the information indicating that an image forming operation is being performed is received. If an image forming operation is being performed, the process returns to step S430. Otherwise, i.e. if the image forming apparatus 2 has discharged the last paper to complete the image forming operation, the process may proceed to step S434.

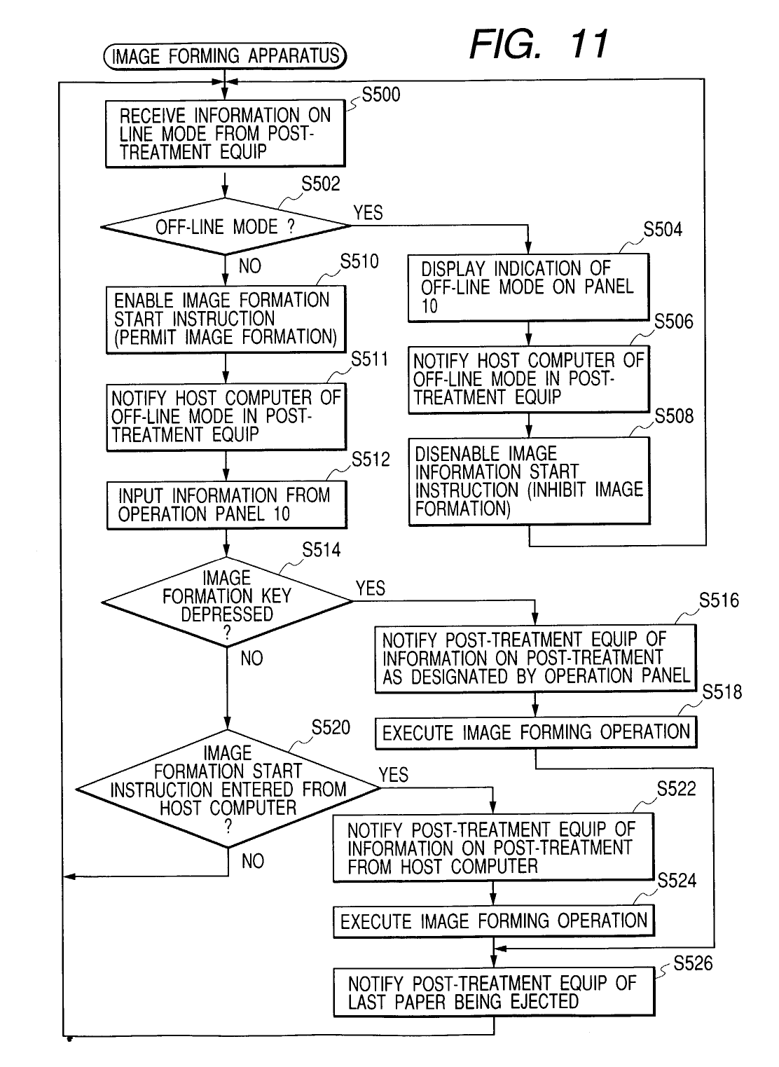

FIG. 11 is a flow chart showing how the image forming apparatus 2 is controlled by the engine controller 31. First, the engine controller 31 receives information, via the communication line 3 from the sheet post-treatment equipment controller 30 of the sheet post-treatment equipment 1, indicating whether the sheet post-treatment equipment is in the on-line or off-line mode (S500). Upon receiving information from the sheet post-treatment equipment controller 30 indicating that the sheet post-treatment equipment is in the off-line mode (S502), the engine controller indicates on the display 12 on the operation panel 10 of the image forming apparatus 2 that the sheet post-treatment equipment 1 is operating in the off-line mode (S504). Then, the engine controller notifies the printer controller 32 that the sheet post-treatment equipment is in the off-line mode. The printer controller 32 then notifies the host computer 50 that the sheet post-treatment equipment is in the off-line mode (S506). Then, the engine controller 31 disables the image formation start instruction, i.e. inhibits the image forming operation (S508). Specifically, the engine controller 31 provides such control that the image forming apparatus does not respond to depression of the image formation start key 11 and notifies the printer controller 32 that no images can be formed. Notified of this, the printer controller 32 accepts a spool of a print job from the host computer 50 and reserves the image formation start instruction given to the engine controller 31. After step S508, the engine controller 31 returns to step S500.

At step S502, upon receiving information from the sheet post-treatment equipment controller 30 indicating that the sheet post-treatment equipment is in the on-line mode, the engine controller enables the image formation start instruction, i.e. permits an image forming operation (S510). Specifically, the engine controller provides such control that the image forming apparatus responds to the image formation start key 11 and notifies the printer controller 32 that images can be formed. Notified of this, the printer controller 32 outputs image information and control information to the engine controller 31 in order to cause the spooled and reserved print job to form an image. Then, the engine controller 31 notifies the printer controller 32 that the sheet post-treatment equipment is in the on-line mode. The printer controller 32 then notifies the host computer 50 that the sheet post-treatment equipment is in the on-line mode (S511). Then, engine controller 13 receives information from the operation panel 10 to determine whether or not the image formation start key 11 has been depressed (S514). If the image formation start key 11 has not been depressed, the engine controller determines whether or not an image formation start instruction is entered from the host computer 50 (S520). If the image formation start instruction is not entered, the process returns to step S500.

If the engine controller determines at step S514 that the image formation start key 11 has been depressed, it transmits the post-treatment information set via the operation panel 10, to the sheet post-treatment equipment controller 30 via the communication line 3 (S516). The engine controller then causes the image forming apparatus 2 to perform an image forming operation of reading originals set on the image forming apparatus 2 and forming the corresponding images on paper (S518). Once one group of originals have been subjected to an image forming operation, the engine controller notifies the sheet post-treatment equipment controller 30 that the last paper has been discharged (S526). The process then returns to step S500. On the other hand, if the engine controller determines at step S520 that the image formation start instruction is entered from the host computer 50, it transmits the post-treatment information from the host computer 50 to the sheet post-treatment equipment controller 30 via the communication line 3 (S522). The engine controller then causes the image forming apparatus 2 to perform an image forming operation of forming an image on paper on the basis of the image information and control information input by the printer controller 32 (S524). The process then proceeds to step S526.

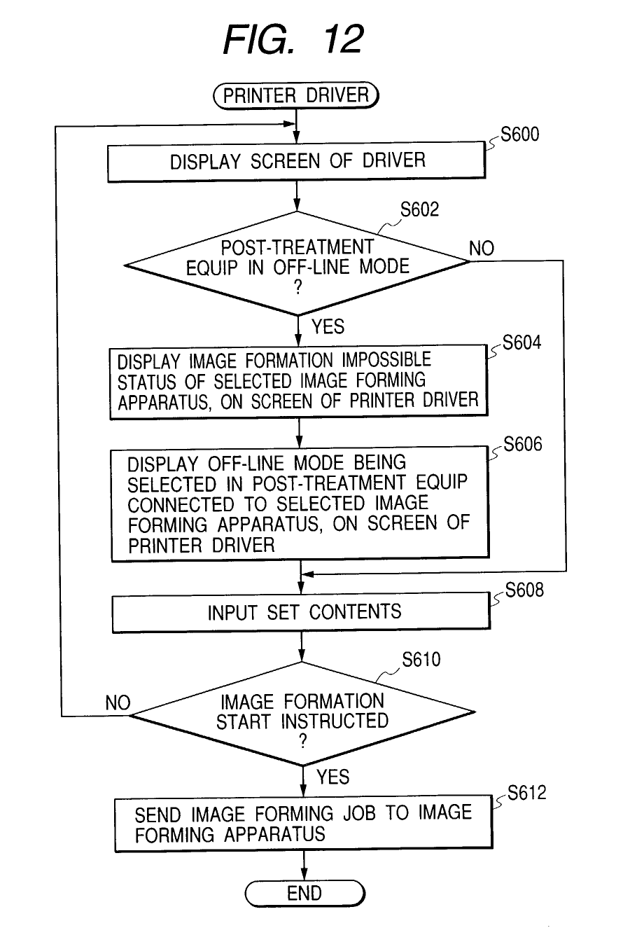

FIG. 12 is a control flow chart for a printer driver program installed in and executed by the host computer 50 so that the host computer 50 can cause the image forming apparatus 2 to form images. The printer driver program is read from a floppy disk or a CD-ROM and then installed in the host computer 50 or is downloaded from a server via the Internet or the like and then installed in the host computer 50.

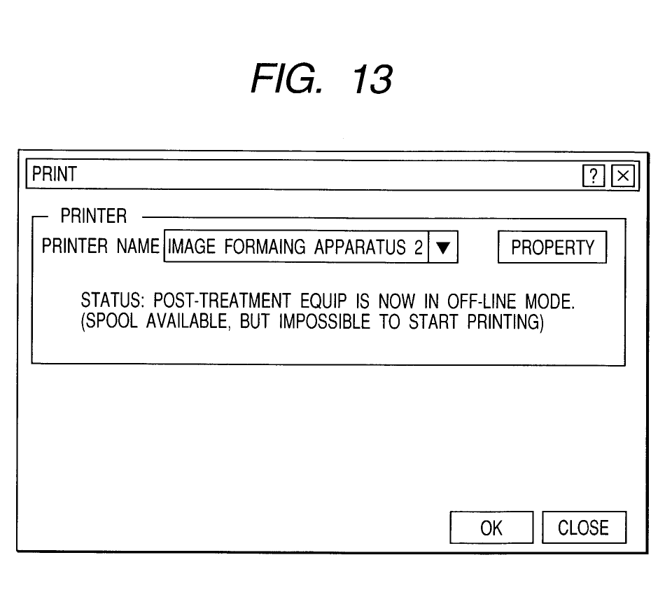

When the printer driver program installed in the host driver 50 is activated, a printer driver screen is displayed (S600). Then, it is determined whether or not the image forming apparatus 2 has notified the host computer that the off-line mode has been selected in the sheet post-treatment equipment 1 (S602). If the off-line mode has been selected in the sheet post-treatment equipment 1, the printer driver screen indicates that the selected image forming apparatus cannot form any images (“Impossible to start printing”) as shown in FIG. 13 (S604). The printer driver screen also indicates that the offline mode has been selected in the sheet post-treatment equipment 1 connected to the selected image forming apparatus 2 (“Sheet post-treatment equipment is now in off-line mode”) (S606). Then, the contents of information set on the printer driver screen are entered (S608). If it is determined at step S602 that the host computer has not been notified that the off-line mode has been selected, then the process proceeds to step S608.

After step S608, it is determined whether or not an image forming start instruction has been given, i.e. an OK button has been clicked (S610). If the image forming start instruction has not been given, the process returns to step S600. Otherwise, an image forming job is transmitted to the image forming apparatus 2 (S612). Then, the process is ended.

As described above, according to the sheet processing apparatus of the present invention, it is possible to select either a first mode in which a predetermined process is executed on a sheet supplied by the image forming apparatus or a second mode in which a predetermined process is executed on a sheet supplied to the sheet processing apparatus by the user. Further, information indicative of a selected mode is transmitted to the image forming apparatus. This enables the image forming apparatus to be prevented from starting an image forming operation when the second mode is selected in the sheet processing apparatus.

Furthermore, if the first mode is selected, the first or second mode can be selected before the image forming apparatus starts the image forming operation. On the other hand, the selection of the first or second mode is inhibited after the image forming apparatus has started the image forming operation. This provides the advantage that sheets already discharged by the image forming apparatus are not influenced.

Moreover, the inhibition of selection of the first or second mode is canceled after the image forming apparatus has discharged the last sheet to complete the image forming operation. Consequently, the user can select the first or second mode without being troubled after the image forming apparatus has discharged the last sheet to complete the image forming operation.

Further, the present invention provides an image forming apparatus which forms an image on a sheet and to which the sheet processing apparatus is connected, characterized in that information indicative of a selected one of the first and second mode is received, and when the received information is indicative of the second mode, the image forming operation is inhibited. This prevents sheets discharged by the image forming apparatus from being mixed with sheets set in the sheet processing apparatus by the user.

Furthermore, in response to the received information indicating the second mode, an instruction to start an image forming operation of forming a read original image on a sheet is disabled. Consequently, the simple configuration can be used to prevent sheets from the image forming apparatus from being mixed.

Moreover, in response to the received information indicating the second mode, information indicating that no images can be formed is displayed. Accordingly, the user can be notified beforehand that no images can be formed.

Furthermore, in response to the received information indicating the second mode, information indicating that the second mode has been selected is displayed. Accordingly, the user can be notified beforehand that the second mode has been selected.

Moreover, in response to the received information indicating the second mode, the host computer is notified that the second mode has been selected in the sheet processing apparatus. Consequently, the host computer can determine that the second mode has been selected in the sheet processing apparatus.

Furthermore, spooling of image information from the host computer is not inhibited but the image forming operation based on the spooled image information is reserved and thus the image forming operation is inhibited. This prevents mixture of sheets and ensures the host computer user's convenience.

Further, the present invention provides a printer driver program installed in and executed by the host computer in order to allow the image forming apparatus to form an image. With this printer driver program, it is determined whether or not the host computer has been notified that the second mode has been selected in the sheet processing apparatus. In response to the determination that the second mode has been selected, the printer driver screen, displayed on the display of the host computer, indicates that the image forming apparatus cannot form any images. Accordingly, the host computer user can be notified beforehand that no images can be formed.

Furthermore, the present invention provides a printer driver program installed in and executed by the host computer in order to allow the image forming apparatus to form an image. With this printer driver program, it is determined whether or not the host computer has been notified that the second mode has been selected in the sheet processing apparatus. In response to the determination that the second mode has been selected, the printer driver screen, displayed on the display of the host computer, indicates that the second mode has been selected in the sheet processing apparatus. Accordingly, the host computer user can be notified beforehand that the second mode has been selected in the sheet processing apparatus.

What is claimed is:

1. An image forming apparatus, comprising:
image forming means for forming an image on a sheet;
sheet processing means for executing a predetermined process on the sheet;
selecting means for selecting either a first mode in which a predetermined process is executed on a sheet supplied by said image forming means or a second mode in which a predetermined process is executed on a sheet supplied to said sheet processing means by a user; and
inhibiting means for inhibiting said image forming means from performing an image forming operation in response to selection of said second mode by said selection means.

2. An image forming apparatus according to claim 1, further comprising instruction inputting means via which an instruction to start the image forming operation is input,
wherein said inhibiting means disables entries via said instruction inputting means.

3. An image forming apparatus according to claim 1, further comprising display means for indicating that the image forming operation cannot be performed, in response to the selection of said second mode by said selecting means'.

4. An image forming apparatus according to claim 1, wherein said image forming apparatus can form an image on the basis of image information from a host computer, and
said image forming apparatus further comprises notifying means for notifying said host computer that said second mode has been selected, in response to the selection of said second mode by said selecting means.

5. An image forming apparatus according to claim 4, wherein said inhibiting means does not inhibit spooling of the image information from said host computer but reserves and thus inhibits the image forming operation based on the spooled image information.

6. An image forming apparatus according to claim 1, wherein if said selecting means selects said first mode, said selecting means can carry out selection before said image forming apparatus starts the image forming operation, and said selecting means is inhibited from carrying out the selection after said image forming apparatus has started an image forming operation.

7. An image forming apparatus according to claim 6, wherein said inhibiting means cancels the inhibition of the selection by said selecting means after said image forming apparatus has discharged the last sheet to complete the image forming operation.

8. An image forming apparatus, which is capable of attaching to a sheet processing apparatus, said sheet processing apparatus including selecting means for selecting either a first mode in which a predetermined process is executed on a sheet supplied by said image forming means or a second mode in which a predetermined process is executed on a sheet supplied to said sheet processing means by a user, comprising:
image forming means for forming an image on a sheet;
receiving means for receiving, from transmitting means, information indicative of a mode selected by said selecting means; and
inhibiting means for inhibiting an image forming operation in response to the information received by said receiving means indicating said second mode.

9. A printer driver program installed in and executed by a host computer in order to allow said image forming apparatus according to claim 4 to form an image, said printer driver program comprising a program for executing the steps of:
determining whether or not the host computer is notified of the selection of the second mode in said sheet processing apparatus, by said notification means; and
indicating that said image forming apparatus cannot execute the image forming operation, in a printer driver screen displayed on a display of said host computer, in response to determination that the selection of said second mode is notified, in said determining step.

10. A printer driver program installed in and executed by a host computer in order to allow said image forming apparatus according to claim 4 to form an image, said printer driver program comprising a program for executing the steps of:
determining whether or not the host computer is notified of the selection of the second mode in said sheet processing apparatus, by said notification means; and
indicating that said second mode has been selected in said sheet processing apparatus, in a printer driver screen displayed on a display of said host computer, in response to determination that the selection of said second mode is notified, in said determining step.

11. An image forming apparatus, comprising:
an image forming unit that forms an image on a sheet;
a sheet processing unit that executes a predetermined process on the sheet;
a selector that selects either a first mode in which a predetermined process is executed on a sheet supplied by said image forming unit or a second mode in which a predetermined process is executed on a sheet supplied to said sheet processing unit by a user; and
a controller that inhibits said image forming unit from performing an image forming operation in response to selection of said second mode by said selector.
